(19) United States
(12) Patent Application Publication
(10) Pub. No.: US 2025/0314522 A1
(43) Pub. Date: Oct. 9, 2025

(54) LOAD DETECTION METHOD

(71) Applicant: ZF Friedrichshafen AG, Friedrichshafen (DE)

(72) Inventors: Marcel-Frederic BÖHSE, Preußisch Oldendorf (DE); Alexander LUNDBERG, Melle (DE); Julian STRATMANN, Bad Essen (DE); Tobias CRÖNERT, Ravensburg (DE)

(73) Assignee: ZF Friedrichshafen AG, Friedrichshafen (DE)

(21) Appl. No.: 19/169,442

(22) Filed: Apr. 3, 2025

(30) Foreign Application Priority Data
Apr. 5, 2024 (DE) 10 2024 203 112.7

(51) Int. Cl. G01G 19/08; B60W 40/13

(52) U.S. Cl. CPC G01G 19/086; B60W 40/13; B60G 2400/61; B60W 2040/1307

(57) ABSTRACT

The load can be detected for a vehicle having a chassis with vehicle wheels on a ground surface, a vehicle body supported in a sprung manner on unsprung components of the chassis. A wheel stroke for each vehicle wheel characterizes a vertical distance from the vehicle body. With the vehicle at rest, one or more wheel strokes are determined as static wheel stroke data, which are used with suspension information characterizing suspension behavior of the vehicle body to determine a static mass of the vehicle and/or vehicle body. While the vehicle is travelling, at least one drive-dynamical parameter of the vehicle is determined on the basis of which a dynamic mass of the vehicle and/or the vehicle body is determined. Suspension information is produced or corrected based on a comparison of the dynamic mass and the static mass.

### RELATED APPLICATIONS

This application claims the benefit of and right of priority under 35 U.S.C. § 119 to German Patent Application no. 10 2024 203 112.7, filed on 5 Apr. 2024, the contents of which are incorporated herein by reference in its entirety.

### FIELD OF THE DISCLOSURE

The invention relates to a method for load determination in a vehicle, which comprises a chassis with a plurality of vehicle wheels which stand or roll on a ground surface, and a vehicle body carried by the chassis, which is supported in a sprung manner on unsprung components of the chassis, which includes the vehicle wheels with each of which is associated a respective wheel stroke that characterizes a distance from the vehicle body in a vertical direction of the vehicle, wherein when the vehicle is stationary at least one or more of the wheel strokes is determined as a static wheel stroke datum, preferably by measurement, and from the static wheel stroke datum and from suspension information that characterizes the suspension behavior of the vehicle body, particularly relative to the unsprung components, a mass of the vehicle and/or of the vehicle body is determined as a static mass.

### BACKGROUND

The suspension information comprises, for example, a characteristic line or suspension rigidity such that from it and from the wheel stroke the static mass can be determined, for example using Hooke's law and Newton's second law, taking gravitational acceleration into account. If the mass of the unloaded vehicle and/or vehicle body is known, then from the static mass the mass of the load can also be determined. The problem is that the suspension information can change over time, for example due to settling processes and/or material fatigue.

Furthermore, from the prior art, the determination of the load and/or the mass of a vehicle during driving is known, and this can be done with relatively high precision. For example, DE 10 2013 211 243 A1 discloses a method by which the vehicle mass of a travelling motor vehicle is determined, wherein a speed signal, a longitudinal acceleration signal, a braking signal and a drive input signal are taken into account, in such manner that a force balance of the longitudinal dynamics of the motor vehicle is evaluated and such that the longitudinal acceleration signal is measured by an inertial sensor. An evaluation of the force balance of the longitudinal dynamics takes place both during acceleration and during braking processes, wherein a number of raw mass values is calculated and wherein the vehicle mass is determined with reference to a statistical evaluation of the raw mass values that includes the formation of at least one average value.

In addition, BP 1 863 659 B1 describes a method for determining the mass of a vehicle or a mass fraction of a vehicle pertaining to an individual wheel with a wheel suspension that enables a vertical movement between the vehicle body and the vehicle wheels, wherein the mass estimation is carried out by means of a status observer based on the vertical dynamics of the vehicle. The mass of the vehicle body and/or that of the so-termed unsprung masses and/or the mass moment of inertia of the body about the longitudinal axis of the vehicle and/or about the transverse axis of the vehicle is determined by means of a preferably non-linear status observer which evaluates the vertical dynamics of the vehicle. For this, preferably stimuli of the vehicle body due to acceleration and/or braking processes and/or steering maneuvers of the vehicle are taken into account by modeling the longitudinal dynamics and/or the transverse dynamics, either by means of a physical model, in particular a single-track or dual-track model, or by virtue of the measured longitudinal and/or transverse accelerations.

### SUMMARY

However, if the mass is determined exclusively while driving and not before driving begins, several disadvantages can arise since the journey starts with a possibly overloaded vehicle. For example, with an overloaded vehicle a dangerous situation may occur. Furthermore, depending on the route to be covered the overload would have to be removed from the vehicle. Moreover, for electrically powered vehicles a load-dependent range forecast is relevant in order to be able to estimate how much more loading can be added without having to re-charge the battery.

Starting from there, the particular purpose of the present invention is to be able to increase the accuracy of the determination of static mass.

According to the invention, this objective is achieved by a method according to claim 1. Preferred further developments of the invention emerge from the subordinate claims and from the description given below.

A method for load determination in a vehicle, which comprises a chassis with a plurality of vehicle wheels which stand or roll on a ground surface, and a vehicle body carried by the chassis, which is supported in a sprung manner on unsprung components of the chassis, which includes the vehicle wheels with each of which is associated a respective wheel stroke that characterizes a distance from the vehicle body in a vertical direction of the vehicle, wherein when the vehicle is at rest at least one or more of the wheel strokes is determined as a static wheel stroke datum, preferably by measurement, and from the static wheel stroke datum and from suspension information that characterizes the suspension behavior of the vehicle body, particularly relative to the unsprung components, a mass of the vehicle and/or of the vehicle body is determined as a static mass, is according to the invention in particular developed further as follows:
during a journey of the vehicle at least one drive-dynamical parameter of the vehicle is determined,
on the basis of the at least one drive-dynamical parameter a mass of the vehicle and/or the vehicle body is determined as a dynamic mass, and
the dynamic mass is compared with the static mass and as a function of the comparison the suspension information is produced and/or corrected.

The above partial expression “as a function of the comparison” means specifically “as a function of the comparison” and/or “as a function of the result of the comparison”. The load determination method can for example also be called a method for mass determination. By virtue of the further development according to the invention the suspension information can be produced and/or corrected on the basis of the relatively accurately determinable dynamic mass, which results in an increase of the precision of the suspension information and thereby increases the precision of the static mass determination.

The vehicle is in particular associated with a vehicle co-ordinate system that preferably contains a longitudinal axis and/or a transverse axis and/or a vertical axis of the vehicle. The longitudinal axis of the vehicle extends in particular in a longitudinal direction of the vehicle. The transverse axis of the vehicle extends in particular in a transverse direction of the vehicle. The vertical axis of the vehicle extends in particular in the vertical direction of the vehicle, which for example is also called the vertical direction. The longitudinal axis, and transverse axis and the vertical axis of the vehicle, in that sequence, form in particular an orthogonal system of co-ordinates. The expression “at least one” also specifically includes the meaning of “one” or “exactly one”.

The vehicle body carried by the chassis is preferably supported in a sprung manner by vehicle springs on the unsprung components of the chassis. Preferably, one or at least one of the vehicle springs is associated with each vehicle wheel. The suspension information includes in particular information about one or more of the vehicle springs or about the vehicle wheels or all of them.

Instead of the expression “suspension information”, for example, the expression “at least one suspension information” or the expression “suspension data” can also be used. The suspension information includes in particular at least one or more suspension information value which, for example, characterizes at least one or more spring rigidities and/or at least one or more spring characteristics. Preferably the suspension information, particularly in the form of the at least one or more suspension information values, is stored in a memory unit. For example, the suspension information, particularly in the form of the at least one or more suspension information values, is stored in a table or in the form of at least one table. In this case intermediate values not stored in the at least one table can be determined, for example, by interpolation. The at least one table is in particular a look-up table.

The vehicle wheels are preferably articulated to the vehicle body by means of chassis control arms. In particular, one or at least one of the chassis control arms is associated with each vehicle wheel. For example, two or at least two, three, or at least three, four, or at least four of the chassis control arms are associated with each vehicle wheel.

The vehicle wheels are connected to the vehicle body by way of dampers. In particular, one or at least one such damper is associated with each vehicle wheel.

In an advantageous design the vehicle comprises at least one drive motor by means of which at least one of the vehicle wheels or at least two of the vehicle wheels or the vehicle wheels or all of the vehicle wheels are and/or can be driven. Preferably, the at least one drive motor comprises a motor shaft which, for example is and/or can be coupled via the interposition of at least one vehicle transmission, preferably indirectly or at least indirectly, to at least one of the vehicle wheels or at least two of the vehicle wheels or the vehicle wheels or all of the vehicle wheels.

Preferably, from the static mass the mass of the vehicle's load is determined, in particular having regard to the mass of the unloaded vehicle and/or the unloaded vehicle body. For example, the mass of the unloaded vehicle and/or the unloaded vehicle body is subtracted from the static mass. In addition, or alternatively, from the dynamic mass the mass of the vehicle's load is determined, in particular taking into account the mass of the unloaded vehicle and/or the unloaded vehicle body. For example, the mass of the unloaded vehicle and/or the unloaded vehicle body is subtracted from the dynamic mass. Preferably, the mass of the unloaded vehicle and/or the unloaded vehicle body is known and/or predetermined.

Preferably, with the vehicle at rest the wheel stroke or all the wheel strokes is/are determined in particular as static wheel stroke data, preferably by measurement. The static wheel stroke information includes in particular at least one or more of the wheel strokes or the wheel stroke or all the wheel strokes when the vehicle is at rest. Instead of the expression “static wheel stroke information”, for example the expression “at least one static wheel stroke datum” or the expression “static wheel stroke data” can be used. The static wheel stroke information includes in particular at least one or more static wheel stroke values. Preferably the static wheel stroke information, particularly in the form of the at least one or more static wheel stroke values, is stored in the memory unit or in a memory unit.

Preferably, while the vehicle is travelling at least one or more of the wheel strokes or the wheel stroke or all the wheel strokes is/are determined as dynamic wheel stroke information by measurement. The dynamic wheel stroke information includes in particular information about at least one or more of the wheel strokes or about the wheel stroke or all the wheel strokes during the journey of the vehicle. Instead of the expression “dynamic wheel stroke information”, for example the expression “at least one dynamic wheel stroke datum” or the expression “dynamic wheel stroke data” can be used. The dynamic wheel stroke information includes in particular at least one at least one or more dynamic wheel stroke values. Preferably the dynamic wheel stroke information, particularly in the form of the at least one or more dynamic wheel stroke values, is stored in the memory unit or in a memory unit.

Preferably, the at least one drive-dynamical parameter of the vehicle includes at least one parameter of the longitudinal dynamics of the vehicle. In that case the dynamic mass can be determined for example in accordance with DE 10 2013 211 243 A1. Preferably, on the basis of at least one or of the at least one parameter of the longitudinal dynamics of the vehicle, the dynamic mass and/or a longitudinal mass datum that characterizes the mass of the vehicle and/or of the vehicle body is determined. For example, the dynamic mass is determined and/or formed from the longitudinal mass datum.

In addition, or alternatively, the at least one drive-dynamical parameter of the vehicle includes at least one parameter of the vertical dynamics of the vehicle. In that case the dynamic mass can be determined for example in accordance with EP 1 863 659 B1. Preferably, on the basis of the at least one vertical dynamics parameter or among other things on the basis of the at least one vertical dynamics parameter, the dynamic mass and/or a vertical mass datum that characterizes the mass of the vehicle and/or the mass of the vehicle body is determined. For example, the dynamic mass is determined and/or obtained from the vertical mass datum.

In an advantageous further development, on the basis of at least one or the at least one parameter of the longitudinal dynamics of the vehicle the longitudinal mass information or a longitudinal mass datum that characterizes the mass of the vehicle or that of the vehicle body is determined, and on the basis of, or among other things on the basis of at least one or of the at least one parameter of the vertical dynamics of the vehicle, the vertical mass information that characterizes the mass of the vehicle or that of the vehicle body is determined. Preferably, the dynamic mass is determined and/or obtained from, or on the basis of, or taking into account the longitudinal mass information and/or the vertical mass information. In particular, in this case the dynamic mass is determined both on the basis of the longitudinal dynamics and on the basis of the vertical dynamics, whereby the accuracy of the determination of the dynamic mass can be increased still further. For example, the longitudinal mass information is determined in accordance with DE 10 2013 211 243 A1 and the vertical mass information is determined in accordance with EP 1 863 659 B1.

The vertical mass information can for example additionally be determined on the basis of a parameter of the longitudinal dynamics or the at least one parameter of the longitudinal dynamics of the vehicle. In addition, or alternatively, the longitudinal mass information can for example additionally be determined on the basis of a parameter of the vertical dynamics or the at least one parameter of the vertical dynamics of the vehicle. The dynamic mass is determined for example on the basis of a parameter of the longitudinal dynamics or the at least one parameter of the longitudinal dynamics of the vehicle and/or on the basis of a parameter of the vertical dynamics or the at least one parameter of the vertical dynamics of the vehicle.

The at least one drive-dynamical parameter includes in particular one or more drive-dynamical parameters. For example, the at least one drive-dynamical parameter includes a speed of the vehicle and/or at least one acceleration of the vehicle and/or at least one acceleration of the vehicle body and/or a drive torque delivered by the at least one drive motor and/or a rotation speed of the motor shaft of the at least one drive motor and/or at least one or more of the wheel stroke or strokes or all of the wheel strokes that occur during the journey and/or the dynamic wheel stroke information and/or at least one wheel acceleration of at least one, or of each vehicle wheel and/or at least one wheel rotation speed of at least one, or of each vehicle wheel and/or information about a brake actuation of the vehicle and/or at least one or more rotation speeds or turning rates of the vehicle body, in particular about one or more of the axes of the co-ordinate system of the vehicle.

An acceleration in the longitudinal direction of the vehicle is called in particular the longitudinal acceleration. An acceleration in the transverse direction of the vehicle is in particular called the transverse acceleration. An acceleration in the vertical direction of the vehicle is called in particular the vertical acceleration.

The at least one acceleration of the vehicle is or includes, for example, a longitudinal acceleration of the vehicle and/or a transverse acceleration of the vehicle and/or a vertical acceleration of the vehicle.

The at least one acceleration of the vehicle body is or includes, for example, a longitudinal acceleration of the vehicle body and/or a transverse acceleration of the vehicle body and/or a vertical acceleration of the vehicle body.

The at least one wheel acceleration of the at least one wheel, or of each vehicle wheel, includes for example a longitudinal acceleration of the at least one wheel, or of each vehicle wheel and/or a transverse acceleration of the at least one wheel, or of each vehicle wheel and/or a vertical acceleration of the at least one, or of each vehicle wheel.

The at least one or more rotation speeds or turning rates of the vehicle body (body turning rates) are or include in particular a rotation speed or turning rate of the vehicle body about the longitudinal axis, or about a longitudinal axis of the vehicle, and/or a rotation speed or turning rate of the vehicle body about the transverse axis, or about a transverse axis of the vehicle, and/or a rotation speed or turning rate of the vehicle body about the vertical axis, or about a vertical axis of the vehicle.

The at least one acceleration of the vehicle can for example be determined by at least one acceleration sensor, which is preferably a multi-dimensional, in particular a three-dimensional acceleration sensor. Preferably, such an acceleration sensor is provided on at least one vehicle wheel or on each vehicle wheel.

The at least one acceleration of the vehicle body and/or the at least one rotation speed or turning rate of the vehicle body can for example be determined by at least one inertial sensor, which preferably comprises three acceleration sensors and three turning rate sensors. Preferably, the inertial sensor is provided on the vehicle body.

The at least one wheel rotation speed of the at least one, or of each vehicle wheel can in particular be determined by at least one wheel rotation speed sensor on the at least one vehicle wheel or by at least one wheel rotation speed sensor provided on each vehicle wheel.

The speed of the vehicle can be determined, for example, by a tachometer and/or by evaluating the wheel rotation speed or each wheel rotation speed.

The at least one, or each wheel stroke and/or the static wheel stroke information and/or the dynamic wheel stroke information can in particular be determined by at least one or more height level sensors.

The at least one drive torque delivered by the drive motor and/or the rotation speed of the motor shaft of the at least one drive motor are in particular provided by a control unit and/or by a bus system of the vehicle. The control unit is or comprises, for example, a motor control unit. The bus system is or comprises for example a CAN bus.

The vehicle preferably comprises a vehicle brake unit and/or a brake lever. The brake lever is in particular part of the vehicle brake unit and/or is connected thereto. The information about a brake actuation of the vehicle is for example characterized or provided by at least one brake pressure of the vehicle brake unit and/or by an actuation travel of the brake lever of the vehicle and/or by an actuation angle of the brake lever of the vehicle and/or by a brake lever force exerted on the brake lever of the vehicle. The brake lever is preferably a foot-pedal and is for example also called the brake pedal.

The information about a brake actuation of the vehicle is for example provided by the control unit, in particular via the bus system of the vehicle.

In an advantageous further development, the dynamic mass is additionally determined on the basis of at least one supplementary parameter.

For example, the at least one supplementary parameter includes the brake pressure, or a brake pressure of the vehicle brake unit and/or the actuation travel, or an actuation travel of the brake lever or the actuation angle, or an actuation angle of the brake lever and/or the brake level force, or a brake lever force exerted on the brake lever.

Preferably, a brake disk is provided on one of the vehicle wheels or on all of them. Preferably, the temperature of the, or of each brake disk is measured. Advantageously, the at least one supplementary particular includes the temperature of the at least one brake disk, or of each brake disk.

The vehicle preferably comprises a drive lever. Preferably, the at least one supplementary parameter includes an actuation travel of the drive lever and/or an actuation angle of the drive lever and/or a drive lever force exerted on the drive lever. The drive lever is preferably a foot-pedal and is also called the accelerator pedal or the gas pedal.

On the basis of the comparison and/or as the result of the comparison between the dynamic mass and the static mass, an evaluation datum is preferably formed, which in particular characterizes a deviation of the dynamic mass from the static mass and/or a difference between the dynamic mass and the static mass. For example, the evaluation datum includes one or at least one key evaluation value or is formed thereby.

Preferably, the suspension information and/or the at least one or more suspension information values is/are produced and/or corrected as a function of the comparison of the dynamic mass with the static mass, and/or as a function of or taking into account the evaluation information.

Preferably, the suspension information includes one or at least one spring rigidity datum. The suspension information and/or the at least one spring rigidity datum preferably characterize(s) at least one spring rigidity in the suspension behavior of the vehicle body. In particular, the suspension information and/or the spring rigidity datum includes one or more spring rigidity values, each of which in particular forms one of the suspension information values. Advantageously, the at least one or more spring rigidity values characterize(s) at least one or more suspension characteristic curves. Preferably, the spring rigidity information is obtained and/or corrected as a function of the comparison of the dynamic mass with the static mass and/or as a function of the evaluation information. By virtue of the spring rigidity information, it is possible, for example, to take into account a non-linear and/or non-proportional suspension behavior. The spring rigidity information is, or is preferably stored as, at least one table or in the form of at least one table, in particular in the, or in a memory unit. In this case intermediate values that have not been stored can be determined in the at least one table, for example by interpolation. The at least one table is in particular a look-up table.

The suspension behavior of the vehicle body includes in particular a hysteresis in relation to a loading and unloading of the vehicle and/or of the vehicle body. Preferably, the hysteresis is taken into account in the suspension information and/or in the at least one spring rigidity datum. Preferably, the suspension information and/or the at least one spring rigidity datum includes one or at least one hysteresis datum which specifically characterizes the hysteresis. Preferably, the suspension information and/or the hysteresis datum includes at least one or more hysteresis values, which in particular form one of the suspension information values in each case. For example, with the same wheel stroke or strokes and/or the same static wheel stroke information a different static mass is assigned to the vehicle and/or the vehicle body as a function of whether the vehicle is loaded or unloaded. The hysteresis information includes or characterizes in particular at least one or more loading spring rigidity values and/or at least one or more unloading spring rigidity values and/or at least one or more loading spring characteristic curves and/or at least one or more unloading spring characteristic curves. Preferably, the hysteresis information is produced and/or corrected as a function of the comparison of the dynamic mass with the static mass and/or as a function of the evaluation information. By virtue of the hysteresis information, it is for example possible to take into account a hysteresis in the suspension behavior. The hysteresis information is, or is preferably stored as at least one table or in the form of at least one table, specifically in the memory unit or in a memory unit. In this case intermediate values that have not been stored can be determined in the at least one table, for example by interpolation. The at least one table is in particular a look-up table.

According to an advantageous further development, while the vehicle is at rest, a change in the loading of the vehicle is detected preferably by virtue of a change in the mass of the vehicle and/or that of the vehicle body and/or by virtue of a change of the at least one or more than one wheel strokes and/or a change of the static wheel stroke information, and a loading change datum that characterizes the change is prepared. In particular the loading change datum contains information about whether the loading condition of the vehicle remains unchanged or whether the vehicle is loaded or unloaded. Thus, for example it is possible to use the hysteresis information for the determination of the static mass. Preferably, the static mass is determined also taking into account the loading change information. For example, the loading change information includes at least one loading change information value or is formed thereby.

According to an advantageous embodiment the vehicle comprises a holding brake, for example in the form of a hand brake. In particular, the suspension behavior of the vehicle body depends on the actuation status of the holding brake. Preferably, the actuation status of the holding brake is taken into account in the suspension information and/or in the at least one spring rigidity datum and/or in the hysteresis datum, for example by at least one spring rigidity or spring characteristic curve that represents a released holding brake and another spring rigidity or spring characteristic curve that represents an actuated holding brake. Preferably, with the vehicle at rest the actuation status of the holding brake is detected and a holding brake actuation datum that characterizes that status is produced. Advantageously, the static mass is additionally determined taking into account the holding brake actuation datum. The holding brake actuation datum includes, for example, at least one holding brake actuation datum value or is formed thereby.

In an advantageous further development, with the vehicle at rest and in particular on the basis of the static wheel stroke information a center of gravity datum that characterizes the center of gravity of the vehicle is determined. Preferably, on the basis of the center of gravity datum a specifically load-related shift of the center of gravity is determined.

In an advantageous embodiment the production and/or correction of the suspension information takes place by means of an evaluation unit which in particular includes an artificial intelligence module such as a neuronal network and which is preferably connected to the bus system. For example, the suspension information is produced and/or corrected with reference to and/or with the minimization of a quality function. Preferably, additional vehicle information is supplied to the evaluation unit and/or the artificial intelligence module, which information is taken into account when producing and/or correcting the suspension information.

To begin with, the suspension information is in particular specified. However, if at the beginning no, or no sensible suspension information is specified, then a starting or initial suspension information can be produced for example on the basis of a dynamic mass determined while travelling.

Preferably, from the suspension information and from the static or dynamic wheel stroke information a wheel contact force of the at least one, or of the respective or of all the vehicle wheels is determined, whose wheel stroke is incorporated for example in the static or dynamic wheel stroke information and/or in its production. For example, in that way the wheel contact force at each corner of the vehicle is and/or can be determined. Preferably, from the wheel contact force or forces the mass, or a mass of the vehicle and/or of the vehicle body is determined, in particular as the static mass. For example, from the wheel contact force or forces the static mass of the vehicle is determined. The wheel contact force, or each wheel contact force is for example also called the normal force. For example, the wheel contact force or each wheel contact force is a static wheel contact force which occurs in particular when the vehicle is at rest. In addition, or alternatively, for example a dynamic wheel contact force of the at least one, or of the respective or of each vehicle wheel can be determined, for example during the journey or a journey of the vehicle.

In particular, for the determination of the static mass from the static wheel stroke information at least one spring rigidity is needed, which for example can also be called the spring stiffness. Furthermore, it is advantageous to take into account the hysteresis in relation to loading and unloading. With the invention it is in particular possible to learn the suspension information, such as the information about spring rigidity and/or about the hysteresis, with reference to the dynamic mass determined while travelling. The dynamic mass determined by dynamic vehicle trajectories can be determined with a high estimate quality. In addition, with reference to an average value of the wheel deflection relative to the vehicle body over the time during which a vehicle is moving, the estimate quality of the determination of the dynamic mass is improved. In particular, with electrically powered vehicles, due to the linear relationship between motor current and driving force the estimate quality is increased. The spring characteristic curves of the static load recognition are adapted with reference to the comparison of determined static masses with dynamic masses determined later. In such a case on-line adaptation with reference to an optimization process (genetic algorithm) or with reference to an approach based on artificial intelligence is possible.

In addition, data from the bus system, or from a bus system of the vehicle can be used in order to take into account further interfering influences such as open doors, changing damper modes, temperature, stationary times and/or settling times. Furthermore, the influence of a road inclination can be taken into account when determining the dynamic mass and the static mass. Moreover, it is possible to link up with vehicles of the same type in order to shorten the time for learning the suspension information.

The invention makes it possible to determine the static mass by determining the wheel contact force of each wheel by way of the wheel stroke rigidity of each wheel and the deflection of the wheel relative to the vehicle body on the basis of the suspension information produced and/or corrected, which in particular includes hysteresis information that represents a characteristic hysteresis curve. In that case the characteristic hysteresis curve takes into account the loading and unloading process and in particular reproduces the static mass determined on the basis of the deflection of the vehicle wheel relative to the vehicle body as the real vehicle mass. To improve the reproduction quality of the characteristic hysteresis curve and to adapt the wheel stroke rigidity, dynamic movement trajectories of the vehicle are used in order to determine dynamically the vehicle mass as a dynamic mass so that the spring characteristics of the suspension information are always being developed.

### BRIEF DESCRIPTION OF THE DRAWINGS

Below, the invention is described with reference to a preferred embodiment and referring to the drawing, which shows:

FIG. 1: A schematic view of a vehicle seen from above,

FIG. 2: A schematic view of a wheel suspension of the vehicle,

FIG. 3: A schematic view of a device for carrying out the method according to the invention, and

FIG. 4: A schematic diagram to illustrate an embodiment of the method according to the invention.

### DETAILED DESCRIPTION

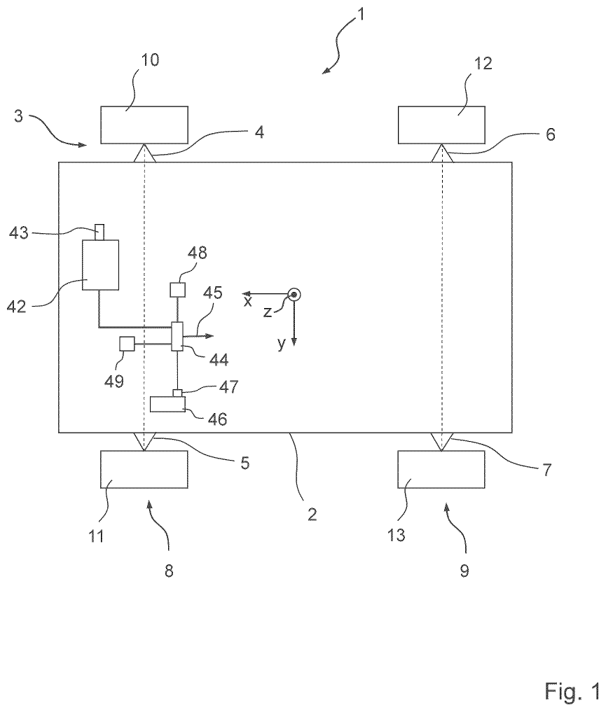

FIG. 1 shows a schematic view of a vehicle 1 seen from above, which comprises a vehicle body 2 and a chassis 3 with a plurality of wheel suspensions 4, 5, 6 and 7, of which the wheel suspensions 4 and 5 are associated with a front axle 8 and the wheel suspensions 6 and 7 are associated with a rear axle 9. Each wheel suspension includes a vehicle wheel, wherein the wheel suspension 4 includes the wheel 10, the wheel suspension 5 the wheel 11, the wheel suspension 6 the wheel 12 and the wheel suspension 7 the wheel 13. In addition, a co-ordinate system with a vehicle axis x, a vehicle axis y and a vehicle axis z is shown.

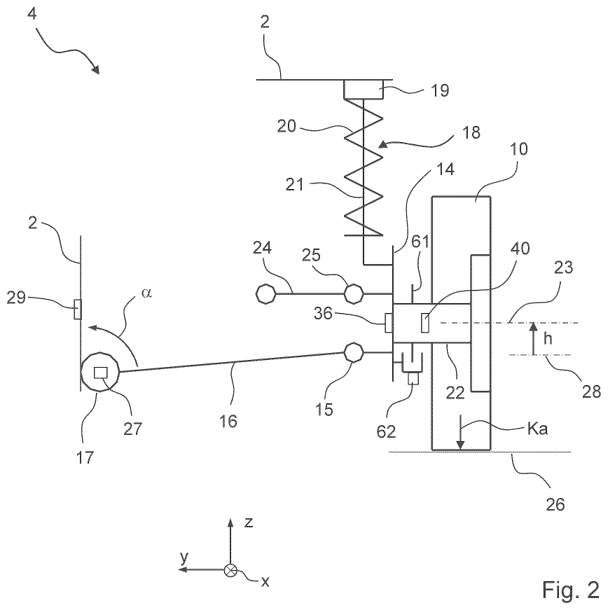

FIG. 2 shows a schematic view of the wheel suspension 4, which comprises a wheel carrier 14 which is connected by a joint 15 preferably in the form of a ball joint to a chassis control arm 16 preferably in the form of a transverse control arm, whose end remote from the wheel carrier 14 is articulated to the vehicle body 2 by at least one joint 17 preferably in the form of a rubber mounting. Furthermore, the wheel carrier 14 is in particular connected fast to a shock absorber 18 whose end remote from the wheel carrier 14 is connected to the vehicle body 2 by a shock absorber supporting bearing 19. The shock absorber 18 comprises a vehicle spring 20 and a damper 21 which is in particular surrounded by the vehicle spring 20 preferably in the form of a helical spring. To the wheel carrier 14 is fixed a wheel bearing 22 by means of which the vehicle wheel 10 is mounted rotatably about a wheel rotation axis 23. In addition, a track-rod 24 is connected to the wheel carrier 14 by a joint 25 preferably in the form of a ball joint. The vehicle wheel 10 is in contact with a ground surface 26, for example a street or road. In particular the vehicle wheel 10 exerts a for example static wheel contact force Ka on the ground surface 26. It should be noted that the vehicle co-ordinate system shown in FIG. 1 is shown displaced in FIG. 2.

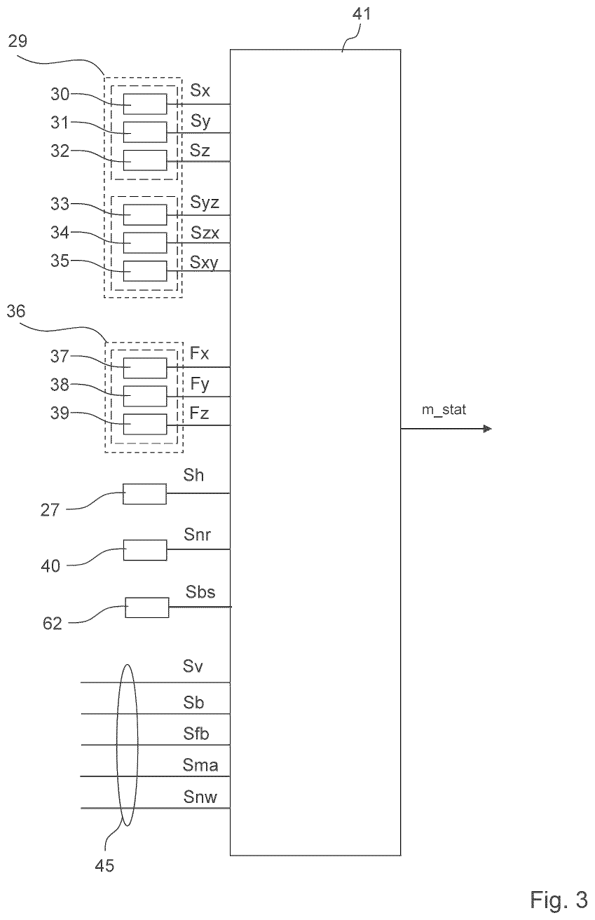

On the joint 17 there is provided a height level sensor 27 by means of which, by measuring an angle α enclosed between the vehicle body 2 and the chassis control arm 17, a wheel stroke h of the vehicle wheel 10 relative to a reference position 28 can be determined and a wheel stroke signal Sh that characterizes the wheel stroke h can be produced. The reference position 28 is in particular positionally fixed on the vehicle body 2. Preferably, a corresponding height level sensor is provided on the other wheel suspensions 5, 6 and 7, by means of which a wheel stroke of each vehicle wheel can be detected and a wheel stroke signal that characterizes the wheel stroke can be produced. In this case the height level sensors together form in particular a height level sensor arrangement. The wheel stroke signal Sh and/or the other wheel stroke signals constitute in particular wheel stroke information. On the vehicle body 2 a body sensor arrangement 29 is provided, which comprises three translational acceleration sensors 30, 31 and 32 and also three turning rate sensors 33, 34 and 35 (see FIG. 3). In this case the acceleration sensor 30 produces in particular an acceleration signal Sx that characterizes a longitudinal acceleration of the vehicle body 2. In addition the acceleration sensor 31 produces an acceleration signal Sy that characterizes a transverse acceleration of the vehicle body 2. Finally, the acceleration sensor 32 produces an acceleration signal Sz that characterizes a vertical acceleration of the vehicle body 2. The turning rate sensor 33 produces in particular a turning rate signal Syz that characterizes a rotation speed or turning rate of the vehicle body 2 about the longitudinal axis x of the vehicle. In addition the turning rate sensor 34 produces in particular a turning rate signal Szx that characterizes a rotation speed or turning rate of the vehicle body 2 about the transverse axis y of the vehicle. In addition the turning rate sensor 34 produces in particular a turning rate signal Szx that characterizes a rotation speed or turning rate of the vehicle body 2 about the transverse axis y of the vehicle. Finally, the turning rate sensor 35 produces in particular a turning rate signal Sxy that characterizes a rotation speed or turning rate of the vehicle body 2 about the vertical axis z of the vehicle.

Furthermore, on the wheel carrier 14 a chassis sensor arrangement 36 is provided, which comprises three translational acceleration sensors 37, 38 and 39 (see FIG. 3). Optionally, the chassis sensor arrangement 36 can also comprise three turning rate sensors. In this case the acceleration sensor 37 produces in particular an acceleration signal Fx that characterizes a longitudinal acceleration of the vehicle wheel 10. In addition, the acceleration sensor 38 produces in particular an acceleration signal Fy that characterizes a transverse acceleration of the vehicle wheel 10. Finally, the acceleration sensor 39 produces in particular an acceleration signal Fz that characterizes a vertical acceleration of the vehicle wheel 10.

Furthermore, on the wheel carrier 14 or the wheel bearing 22 a wheel rotation speed sensor 40 is provided, by means of which a rotation speed of the vehicle wheel 10 can be detected and a wheel rotation speed signal Snr that characterizes that rotation speed can be produced. Preferably, on the other wheel suspensions 5, 6 and 7 a corresponding wheel rotation speed sensor is provided, by means of which a wheel rotation speed of the respective vehicle wheel can be detected and a rotation speed signal that characterizes the rotation speed can be produced.

On the vehicle wheel 10 a brake disk 61 is provided. Preferably, on or in the area of the brake disk 61 a brake disk temperature sensor 62 is provided, by means of which a brake disk temperature signal Sbs of the brake disk 61 can be produced. For example, a corresponding brake disk temperature sensor is also provided on the other wheel suspensions 5, 6 and 7, by means of which a brake disk temperature signal that characterizes the temperature of the brake disk concerned can be produced.

The wheel suspension 5 is preferably made laterally reversed relative to the wheel suspension 4. In particular, the front axle 8 is designed to be steerable. The rear axle can for example be designed to be steerable or not steerable. Apart from that, the wheel suspensions 4, 5, 6 and 7 are in particular designed in the same way.

As can be seen from FIG. 3, the sensors of the sensor arrangements 29 and 36 and the height level sensor 27 and the wheel rotation speed sensor 40 are connected to an evaluation unit 41. Preferably, chassis sensor arrangements of identical form to the chassis sensor arrangement 36 are provided in the wheel suspensions 5, 6 and 7 and are connected to the evaluation unit 41. Preferably, when present the height level sensors and/or the wheel rotation speed sensors are also connected to the evaluation unit 41.

The vehicle 1 comprises a drive motor 42 with a motor shaft 43 which is coupled to the vehicle wheels 10 and 11 for example by way of at least one vehicle transmission. In addition, or alternatively, the motor shaft 43 is coupled for example to the vehicle wheels 12 and 13 by way of a transmission or the at least one transmission. The drive motor 42 is connected to a control unit 44 which is in tum connected to a bus system 45. Preferably, the control unit 44 is or includes a motor control unit or, for example, is connected to a motor control unit. The bus system comprises for example a CAN bus.

Furthermore, the vehicle 1 comprises a brake pedal 46 on which a brake pedal sensor 47 connected to the control unit 44 is provided, by means of which sensor an actuation of the brake pedal 46 can be detected and a signal Sb that characterizes the actuation can be produced. The brake pedal 46 is in particular connected to a vehicle brake unit of the vehicle 1 and/or forms a part of the brake unit. Alternatively, a brake pressure of the vehicle brake unit, or of a vehicle brake unit can be detected and a signal that characterizes the brake pressure can be produced as the brake signal Sb. Thus, the brake signal Sb characterizes information about the actuation of the brake.

In addition, the vehicle 1 comprises an actuation device 48 for a holding brake of the vehicle 1, such as a hand brake. By means of the actuation device 48 which is in particular connected to the control unit 44, a holding brake actuation signal Sfb that characterizes the actuated status of the holding brake can be produced. The actuation device 48 comprises for example a lever connected to the holding brake, such as a hand lever, a pedal connected to the holding brake, or an actuator with an electrical actuating switch connected to the holding brake.

The vehicle 1 comprises, for example, a tachometer 49 preferably connected to the control unit 44, by means of which a speed signal Sv that characterizes the speed on the vehicle 1 can be produced. The tachometer 49 can comprise the wheel rotation speed sensor 40 or sensors and/or be connected thereto. Alternatively, the tachometer can also be provided in addition to the wheel rotation speed sensor 40 or sensors. In particular, from the wheel rotation speeds detected by means of the wheel rotation speed sensor or sensors the tachometer determines the speed of the vehicle 1.

The evaluation unit 41 is connected to the bus system 45, by means of which the brake actuation signal Sb that characterizes the information about a brake actuation, a holding brake actuation signal Sfb that characterizes an actuation of the holding brake, a drive torque signal Sma that characterizes the drive torque delivered by the drive motor 42, and a motor shaft rotation speed signal Snw that characterizes a rotation speed of the motor shaft 43 are supplied to the evaluation unit 41. Preferably, to the evaluation unit 41 are also supplied by the bus system 45 the speed signal Sv that characterizes the current speed of the vehicle 1 which, however, the evaluation unit 41 could for example also determine from the wheel rotation speed signal or signals Snr.

Optionally, the brake disk temperature sensor 62 is also connected to the evaluation unit 41. For example, when present the brake disk temperature sensors provided in the wheel suspensions 5, 6 and 7 are also connected to the evaluation unit 41.

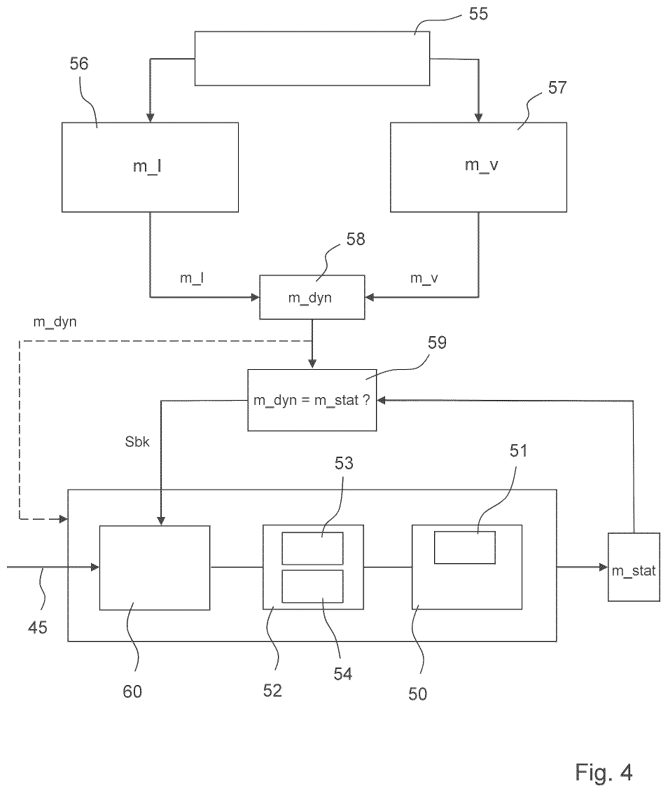

FIG. 4 shows a schematic diagram to illustrate the method according to the invention for load determination in accordance with an embodiment. In a step 50, with the vehicle 1 at rest at least one or more of the wheel strokes are detected as wheel stroke data 51, and the wheel stroke data 51 obtained at rest are termed the static wheel stroke data. From the static wheel stroke data 51 and from suspension information 52 that characterizes the suspension behavior of the vehicle body 2, a mass of the vehicle 1 and/or of the vehicle body 2 is determined as the static mass m_stat. For that purpose, the suspension information 52 comprises at least one or more suspension information values 53 that characterize the at least one spring characteristic. Initially the suspension information 52 is in particular specified.

The suspension behavior of the vehicle body 2 shows a hysteresis in relation to the loading and unloading of the vehicle, and the hysteresis is taken into account in the suspension information. Thus, the suspension information values 53 preferably represent one, or at least one complete suspension characteristic curve that includes hysteresis information. With the vehicle 1 at rest, for example by virtue of a change of the at least one or more wheel strokes it is recognized whether the vehicle 1 is being loaded or unloaded. Thus, in the determination of the static mass the hysteresis can be taken into account.

Furthermore, with the vehicle at rest the holding brake influences the suspension behavior of the vehicle 1. For example, the at least one spring characteristic curve is different when the holding brake is actuated from the at least one spring characteristic curve when the holding brake is released. Preferably, the suspension information includes one or more suspension information values 54 that characterize an additional spring characteristic, such that the suspension information values 54 characterize in particular an actuated holding brake. Thus, the suspension information values 53 preferably represent a released and/or non-actuated holding brake. Preferably, the suspension information values 54 represent one or at least one complete spring characteristic that includes hysteresis information.

In a step 55, while the vehicle 1 is travelling drive-dynamical parameters of the vehicle are determined. The drive-dynamical parameters determined include in particular the speed of the vehicle 1 and/or the acceleration of the vehicle 1 in the longitudinal direction x of the vehicle and/or the drive torque delivered by the drive motor 42 and/or the rotation speed of the motor shaft 43 of the at least one drive motor. Preferably, the drive-dynamical information determined also includes the acceleration of the vehicle 1 in the transverse direction y of the vehicle 1 and/or the wheel rotation speed(s) of at least one or more of the vehicle wheels.

On the basis of these drive-dynamical parameters, in a step 56 a longitudinal mass datum m_l that characterizes the mass of the vehicle and/or of the vehicle body is now determined. Preferably, in doing this the brake signal Sb that characterizes a brake actuation is also taken into account. In addition, still other parameters can be taken into account when determining the longitudinal mass datum m_l.

The determination of the longitudinal mass datum m_l corresponds in particular to a determination of the mass of the vehicle and/or of the vehicle body on the basis of the longitudinal dynamics of the vehicle 1 as explained, for example, in DE 10 2013 211 243 A1.

The drive-dynamical parameters determined additionally include in particular the acceleration of the vehicle body in the vertical direction of the vehicle z and/or the wheel accelerations of the vehicle wheels in the vertical direction of the vehicle z and/or the wheel strokes occurring at one, or more, or at all the vehicle wheels. Preferably, the drive-dynamical parameters determined also include the acceleration of the vehicle body in the transverse direction y of the vehicle and/or the acceleration of the vehicle body in the longitudinal direction x of the vehicle and/or the wheel accelerations of the vehicle wheels in the transverse direction y of the vehicle and/or the wheel accelerations of the vehicle wheels in the longitudinal direction x of the vehicle and/or the rotation speed or turning rate of the vehicle body 2 about the longitudinal axis x of the vehicle and/or the rotation speed or turning rate of the vehicle body 2 about the transverse axis y of the vehicle and/or the rotation speed or turning rate of the vehicle body 2 about the vertical axis z of the vehicle.

On the basis of these drive-dynamical parameters, in a step 57 a vertical mass datum m_v that characterizes the mass of the vehicle or the vehicle body is now determined. In addition, for the determination of the vertical mass datum m_v still other parameters can be taken into account. The wheel stroke information obtained from the wheel stroke or strokes while travelling is in particular termed the dynamic wheel stroke information.

The determination of the vertical mass datum m_v corresponds in particular to a determination of the mass of the vehicle and/or the vehicle body on the basis, or among other things on the basis of the vertical dynamics of the vehicle 1, as explained for example in EP 1 863 659 B1.

In a step 58, on the basis of the longitudinal mass datum m_l and the vertical mass datum m_v a mass of the vehicle and/or of the vehicle body is determined as the dynamic mass m_dyn. In this case the vertical mass datum m_v can be determined many times in advance and then averaged. The same applies to the longitudinal mass datum m_l.

The dynamic mass m_dyn can be determined by averaging the longitudinal mass datum m_l and the vertical mass datum m_v. For example, the dynamic mass m_dyn is determined from the longitudinal mass datum m_l and the vertical mass datum m_v as an unweighted or as a weighted arithmetical mean. In the case of a weighted arithmetical mean, for example various precision levels and/or errors in the determination of the longitudinal mass datum m_l and the vertical mass datum m_v can be taken into account. Since the longitudinal mass datum m_l and the vertical mass datum m_v are determined in different ways, a plausibility test is also possible, for example in such manner that the mass information is always plausible if the values do not deviate by more than a specified amount from one another. Thus, implausible mass data can be rejected. It is also possible that the dynamic mass m_dyn is determined only from or on the basis of the longitudinal mass datum m_l. In that case the vertical mass datum m_v serves, for example, only for plausibility testing. Conversely, it is possible that the dynamic mass m_dyn is determined only from or on the basis of the vertical mass datum m_v. In that case the longitudinal mass datum m_l serves, for example, only for plausibility testing.

In a step 59 the dynamic mass m_dyn is compared with the static mass m_stat, and evaluation information Sbk that characterizes the result of that comparison is produced, in particular in the form of a key evaluation figure and sent to an evaluation unit 60 which corrects the suspension information 52 having regard to the evaluation information Sbk. For that purpose, the evaluation unit 60 can for example determine a new suspension datum and thus overwrite the previous suspension information. In a simple case the evaluation information Sbk is based only on a difference between the static mass and the dynamic mass. Preferably, the correction of the suspension information 52 additionally takes place on the basis of supplementary parameters which are sent to the evaluation unit 60 for example by way of the bus system 45. The evaluation unit 60 comprises in particular an artificial intelligence module such as a neuronal network.

If no, or no rational suspension information 52 is initially available, then a starting or initial suspension information 52 can be produced on the basis of a dynamic mass obtained while travelling, this being indicated by a broken line.

### INDEXES

1 Vehicle
2 Vehicle body
3 Chassis
4 Wheel suspension
S Wheel suspension
6 Wheel suspension
7 Wheel suspension
8 Front axle
9 Rear axle
10 Vehicle wheel
11 Vehicle wheel
12 Vehicle wheel
13 Vehicle wheel
14 Wheel carrier
15 Joint
16 Chassis control arm
17 Joint
18 Shock absorber
19 Shock absorber supporting bearing
20 Vehicle spring
21 Damper
22 Wheel bearing
23 Wheel rotation axis
24 Track-rod
25 Joint
26 Ground surface
27 Height level sensor
28 Reference position
29 Body sensor arrangement
30 Acceleration sensor
31 Acceleration sensor
32 Acceleration sensor
33 Turning rate sensor
34 Turning rate sensor
35 Turning rate sensor
36 Chassis sensor arrangement
37 Acceleration sensor
38 Acceleration sensor
39 Acceleration sensor
40 Wheel rotation speed sensor
41 Evaluation unit
42 Drive motor
43 Motor shaft of the drive motor
44 control unit
45 Bus system
46 Brake pedal
47 Brake pedal sensor
48 Actuation device for the holding brake
49 Tachometer
50 Determination of a static mass
51 Static wheel stroke datum
52 Suspension information
53 Suspension information value(s)
54 Suspension information value(s)
55 Determination of drive-dynamical parameters while travelling
56 Mass determination on the basis of the longitudinal dynamics
57 Mass determination on the basis of the vertical dynamics
58 Determination of a dynamic mass
59 Comparison of the dynamic and static mass
60 Evaluation unit/neuronal network
61 Brake disk
62 Brake disk temperature sensor
α Angle
Fx Acceleration signal
Fy Acceleration signal
Fz Acceleration signal
h Wheel stroke
Ka Wheel contact force
m_dyn Dynamic mass
m_l Longitudinal mass datum
m stat Static mass
m_v Vertical mass datum
Sb Brake actuation signal
Sbk Evaluation datum
Sfb Holding brake actuation signal
Sbs Brake disk temperature signal
Sh Wheel stroke signal
Sma Drive torque signal
Snr Wheel rotation speed signal
Snw Motor shaft rotation speed signal
Sx Acceleration signal
Sy Acceleration signal
Sz Acceleration signal
Syz Turning rate signal
Szx Turning rate signal
Sxy Turning rate signal
x Longitudinal axis of the vehicle
y Transverse axis of the vehicle
Vertical axis of the vehicle

1. A method for load determination in a vehicle (1) having a chassis (3) with a plurality of vehicle wheels (10, 11, 12, 13) which stand or roll on a ground surface (26), and a vehicle body (2) carried by the chassis (3), which is supported in a sprung manner on unsprung components of the chassis (3), which includes the vehicle wheels (10, 11, 12, 13) with each of which is associated a respective wheel stroke (h) that characterizes a distance from the vehicle body (2) in a vertical direction (z) of the vehicle, the method comprising:
determining with the vehicle (1) at rest, one or more of wheel as static wheel stroke data (51);
determining a static mass (m stat) a mass of the vehicle and/or the vehicle body from the static wheel stroke data (51) and from suspension information (52) that characterizes the suspension behavior of the vehicle body (2);
determining, while the vehicle (1) is travelling, at least one drive-dynamical parameter of the vehicle (1);
determining as a dynamic mass (m_dyn), on the basis of the at least one drive-dynamical parameter of the vehicle (1), a mass of the vehicle and/or the vehicle body;
comparing the dynamic mass (m_dyn) with the static mass (m_stat); and
producing the suspension information (52) as a function of comparing the suspension information (52).

2. The method according to claim 1, wherein the at least one drive-dynamical parameter of the vehicle (1) includes at least one parameter of the longitudinal dynamics (Sx, Sv, Sb, Sma, Snw) of the vehicle (1).

3. The method according to claim 1, wherein the at least one drive-dynamical parameter of the vehicle (1) includes at least one parameter of the vertical dynamics (Sz, Sh, Syz, Szx) of the vehicle (1).

4. The method according to claim 3, further comprising:
determining, on the basis of the at least one parameter of the longitudinal dynamics (Sx, Sv, Sb, Sma, Snw) of the vehicle (1), a longitudinal mass datum (m_l) that characterizes the mass of the vehicle and/or that of the vehicle body; p1 determining a vertical mass datum (m v), based on the at least one parameter (Sz, Sh, Syz, Szx) of the vehicle (1), wherein the vertical mass datum (m_v) characterizes the mass of the vehicle and/or the mass of the vehicle body; and
determining the dynamic mass (m_dyn) based on the longitudinal mass datum (m_l) and the vertical mass datum (m_v)

5. The method according to claim 1, wherein the vehicle (1) comprises at least one drive motor (42) by means of which at least one of the vehicle wheels (10, 11) can be driven, the drive motor (42) having a motor shaft (43) coupled to at least one of the vehicle wheels (10, 11).

6. The method according to claim 5, wherein the at least one drive-dynamical parameter includes one or more of (1) a speed (Sv) of the vehicle (1), (ii) a longitudinal acceleration (Fx) of the vehicle (1), (iii) information about a brake actuation (Sb) of the vehicle (1), (iv) a drive torque (Sma) delivered by the drive motor (42), and (v) a rotation speed (Snw) of the motor shaft.

7. The method according to claim 1, wherein the at least one drive-dynamical parameter includes one or more of (i) a vertical acceleration (Sy) of the vehicle body (2), (ii) at least one or more of the wheel strokes (Sh) that occur during the journey, (iii) at least one wheel acceleration (Fy) of at least one of the wheels (10), and (iv) at least one body turning rate (Syz, Szx) about a longitudinal axis (x) of the vehicle and/or about a transverse axis (y) of the vehicle.

8. The method according to claim 1, further comprising:
producing, as a result of comparing the dynamic mass (m_dyn) with the static mass (m_stat), an evaluation datum (Sbk), wherein the evaluation datum (Sbk) characterizes the deviation of the dynamic mass (m_dyn) from the static mass (m_stat); and
producing the suspension information (52) as a function of the evaluation datum (Sbk)

9. The method according to claim 1, wherein the suspension information (52) contains a plurality of suspension information values (53, 54) which characterize at least one spring characteristic curve.

10. The method according to claim 1, wherein producing the suspension information (52) takes into account suspension behavior of the vehicle body (2) in relation to loading and unloading shows a hysteresis, and the method comprises:
detecting a load change of the vehicle with the vehicle at rest; and
producing a load change datum that characterizes the change;
wherein determining the static mass (m_stat) takes into account the load change datum.

11. The method according to claim 1, wherein the vehicle (1) has a holding brake and the suspension behavior of the vehicle body (2) depends on the actuation status of the holding brake, wherein the actuation status is taken into account in the suspension information (52), wherein the method comprises:
detecting the actuation status of the holding brake with the vehicle (1) at rest; and
producing a holding brake actuation datum in such manner that the static mass (m_stat) is additionally determined taking into account the holding brake actuation datum.

12. The method according to claim 1, wherein producing the suspension information (52) take place with the help of an evaluation unit (60) which incorporates a neuronal network.

13. The method according claim 1, comprising determining the load mass of the vehicle (1) from the static mass (m_stat), having regard to the mass of the unloaded vehicle (1) and/or the unloaded vehicle body (2).

14. The method according to claim 1, comprising:
determining from the suspension information (52) and from the static wheel stroke information (51), a wheel contact force (Ka) of each vehicle wheel (10, 11, 12 13);
wherein a wheel stroke (h) is included in the static wheel stroke information (51).

15. The method according to claim 1, wherein producing the suspension information (52) includes correcting the suspension information (52).
